(19) United States
(12) Patent Application Publication
(10) Pub. No.: US 2016/0060079 A1
(43) Pub. Date: Mar. 3, 2016

(54) A RAPID FIXATION MEANS FOR A PASSENGER CONVEYOR

(71) Applicant: OTIS ELEVATOR COMPANY, Farmington, CT (US)

(72) Inventors: Adam Lu, Shanghai (CN); Anna Su, Shanghai (CN); MingLiang Yao, Shanghai (CN); ZhengDong Gui, Shanghai (CN); Benoit Dupont, Shanghai (CN)

(21) Appl. No.: 14/785,012

(22) PCT Filed: Apr. 16, 2014
(86) PCT No.: PCT/US2014/034361

§ 371 Date: Oct. 16, 2015

(30) Foreign Application Priority Data
Apr. 17, 2013 (CN) 201320193560.4

(51) Int. Cl. B66B 29/02; B66B 23/22

(52) U.S. Cl. CPC B66B 29/02; B66B 23/225

(57) ABSTRACT

The present invention relates to a rapid fixation means for a passenger conveyor. More specifically speaking, the present invention relates to a rapid fixation means for mounting into a fixed channel in a base of a lateral structure of a passenger conveyor, the rapid fixation means comprising a connector (4) and a buckle (5) assembly in coordination with one another, the connector (4) having supports capable of elastic deformation, the buckle (5) having a feature of forming a coordination with the supports of the connector (4), the coordination enabling the connector (4) and the buckle (5) to be rapidly joined and detached.

### TECHNICAL FIELD

The present utility model relates to a demountable plug-and-play fixation means for a passenger conveyor, more particularly, relates to a rapid joining/detaching fixation means for a brush and an illumination assembly of the passenger conveyor.

### BACKGROUND OF THE INVENTION

For a passenger conveyor, arranging a brush is an imperative requirement for safety consideration. The brush is arranged on a lateral structure at a lateral edge of the passenger conveyor, and protrudes from the lateral structure. On one hand, the brush covers the space between the lateral edge and the lateral structure of the passenger conveyor, so as to prevent passengers' clothes or limbs from approaching, getting stuck or entangled in the space to incur accidents. On the other hand, the brush avoids foreign objects from falling into the space to cause interference to operation of the conveyor, in favor of extending the service life of the passenger conveyor.

In order to better avoid accidents from happening, a plurality of structural forms are conceived. The form having an illumination function can realize the following situation: even under dim or complicated illumination environments, passengers still can clearly see the positions of steps or treads or tapes of the passenger conveyor, thereby avoiding occurrence of accidents. For details, please see the PCT patent application for an invention entitled “People Conveyor with Brush Guard Lighting” (WO2008/080423) filed by OTIS ELEVATOR COMPANY on Dec. 28, 2006. This application is integrally incorporated in the present application by reference.

For the above passenger conveyor, one common problem is that, the brush or corresponding illumination assembly needs to be replaced during use due to possible damage or natural aging, and the replacing task is usually completed on the site where the conveyor is in operation. Considering that the passenger conveyor is commonly used in such places as markets, stations, airports having a great stream of people, the replacing task shall be quickly completed, thereby minimizing the impact on normal operation of the conveyor. In addition, try to avoid contacting other parts near the brush and illumination assembly as far as possible during the replacing, so as to avoid unnecessary secondary damage to the conveyor.

For the traditional passenger conveyor, the brush and corresponding illumination assembly are usually mounted in the base that is fastened on the lateral structure of the conveyor through fasteners. For example, referring to the PCT application WO2008/080423 as stated in the above text, a skirt brush 16 and a skirt brush illumination means 34 are mounted in channels 24 and 34 formed in a skirt brush profile 26, and the skirt brush profile 26 is fixed on a lateral structure 14 of the conveyor through common fasteners such as screws. If the damaged or aging skirt brush and illumination means are to be replaced, firstly the skirt brush profile 26 must be removed. Moreover, after the replacing is completed, the profile and the replaced skirt brush and illumination means need to be mounted again on the lateral structure. The skirt brush profile 26, the skirt brush 16 and the illumination means 34 can be fabricated into segmental structures, thereby reducing the workload of replacing. However, the on-site dismantling and mounting of the profile still render the whole replacing process take time and efforts, and during the process of multiple dismantling and mounting, it is hard to avoid additional damages to the conveyor.

Hence, there exists in the art a need for a means capable of quickly and conveniently mounting and replacing the brush and corresponding illumination assembly for the passenger conveyor.

### BRIEF SUMMARY OF THE UTILITY MODEL

The present utility model provides a novel rapid joining/detaching fixation means, for fixing a brush and a corresponding illumination assembly or any other similar part of a passenger conveyor. The fixation means enables the mounting and replacing of the brush and corresponding device to be simply and quickly completed, thereby saving time and cost.

More specifically speaking, the present utility model relates to a rapid fixation means for mounting onto a base of a lateral structure of a passenger conveyor, the rapid fixation means comprising a connector and a buckle assembly in coordination with one another, the connector having supports capable of elastic deformation, the buckle having a feature of forming a coordination with the supports of the connector, the coordination enabling the connector and the buckle to be rapidly joined and detached.

In one embodiment, a cavity is formed between the connector and the buckle.

In one embodiment, the supports of the connector form at tail ends hooks that protrude outwards; the buckle forms at lateral end portions hooks that protrude inwards and coordinate with the hooks of the supports at the tail ends; the hooks protruding outwards at the tail ends of the supports and the hooks protruding inwards at the lateral end portions of the buckle overlap in width.

In one embodiment, the connector of the rapid fixation means is capable of being rapidly mounted and dismantled, while the bucket is fixed into a channel of the base on the lateral structure of the passenger conveyor.

In one embodiment, the bucket of the rapid fixation means is capable of being rapidly dismantled and mounted, while the connector is fixed into the channel of the base on the lateral structure of the passenger conveyor.

In one embodiment, a brush of the passenger conveyor is fixed into the channel of the base using the rapid fixation means.

In one embodiment, an illumination assembly is fixed into the channel of the base using the rapid fixation means, and a cable of the illumination assembly is disposed in the cavity between the connector and the buckle.

In one embodiment, the base of the passenger conveyor has two channels, and parts of the passenger conveyor are fixed into one of these two channels using the rapid fixation means.

In one embodiment, the base of the passenger conveyor has a single channel, and the parts of the passenger conveyor are fixed into the single channel using the rapid fixation means.

### BRIEF DESCRIPTION OF THE DRAWINGS

The Drawings reveal several examples of the present utility model in the illustrative manner. In all figures, a same or similar reference sign is used to represent a same or corresponding part.

FIG. 1 shows one example of the present utility model, wherein, the base for the passenger conveyor has two channels, one channel fixing the brush, and another channel fixing the illumination assembly, and wherein, only the illumination assembly is fixed into one channel in the base by adopting the novel rapid fixation means of the present utility model.

FIG. 2 shows a detailed view of the illumination assembly which adopts the novel rapid fixation means of the present utility model.

FIG. 3 shows another example of the present utility model, wherein the brush and the illumination assembly both are fixed into the channels of the base by adopting the novel rapid fixation means of the present utility model.

FIG. 4 shows another example of the present utility model, wherein the brush and the illumination assembly interchange the channels relative to the example as shown in FIG. 3.

FIG. 5 shows another example of the present utility model, wherein two brushes are adopted without the illumination assembly, which two brushes are fixed into their respective channels by adopting the novel rapid fixation means of the present utility model.

Various Examples of the present utility model will be described in details in the following contents in combination with the above Drawings.

### PART LIST

1 Base
2 Brush
3 Illumination Assembly
4 Connector
5 Buckle
6 Cable
7 Waterproof Material
8 Luminophor
9 Luminophor Carrier.

### DETAILED DESCRIPTION OF THE INVENTION

The following text provides a detailed description to the illustrative examples of the present utility model. However, these examples can vary in many manners. Thus, the following illustration is not intended to be restrictive.

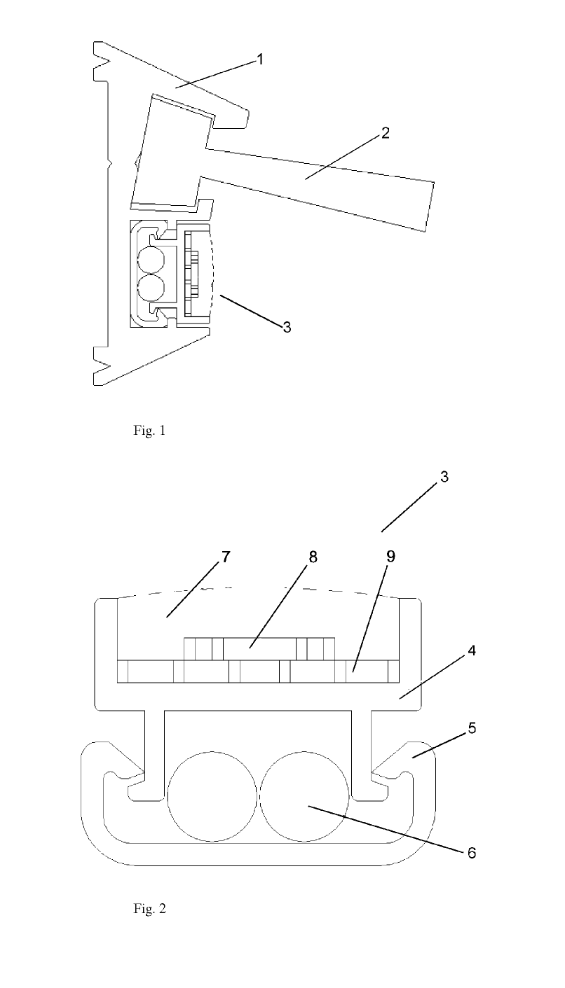

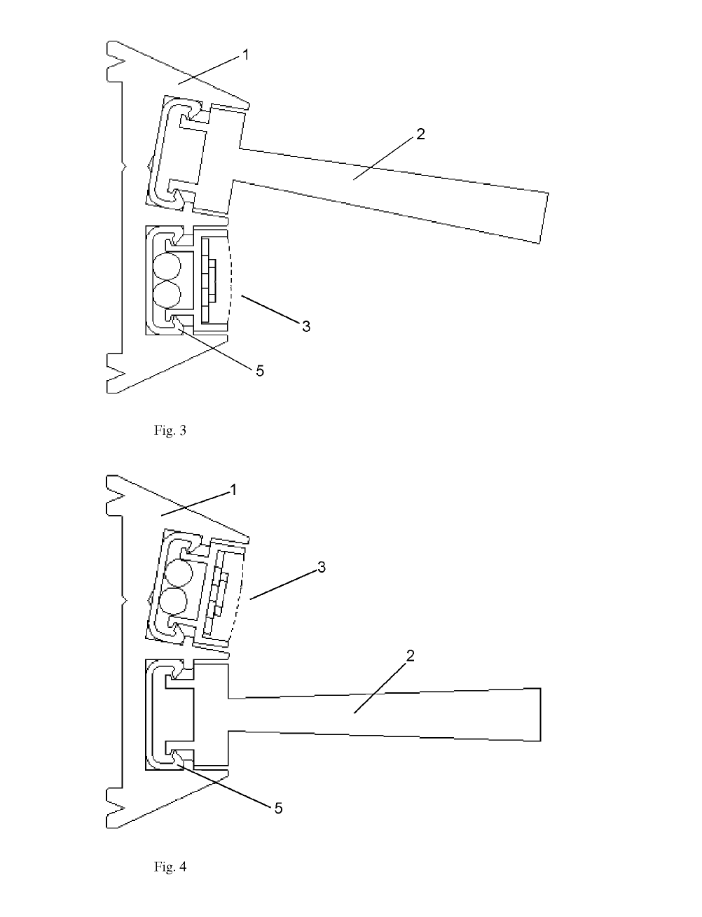

FIG. 1 shows a double-row base 1 for fixing onto a lateral structure of a passenger conveyor, the base 1 having two channels. As shown by the figure, one channel fixes a brush 2 in a traditional manner, while another channel fixes an illumination assembly 3 by adopting the novel rapid fixation means of the present utility model. The details regarding the buckle-type means will be described minutely in the following text by combining FIG. 2.

From FIG. 2, it can be clearly seen that, the rapid fixation means of the present utility model involves two parts coordinating with each other: a connector 4 for supporting the illumination assembly 3, and a buckle 5 for forming a buckle coordination with the connector 4. The connector 4 forms supports at two sides of its bottom respectively, and the supports have hooks that protrude outwards at tail ends. The buckle 5 respectively forms at two lateral end portions hooks that protrude inwards. The hooks protruding outwards and the hooks protruding inwards overlap in width. Since the supports of the connector 4 have elasticity (e.g., fabricated from elastic metal or plastic), when the connector 4 is pressed towards inside the buckle 5, due to coordination action of hooks, the two supports of the connector 4 contract inwards and enters the buckle 5, thereby enabling the hooks on the two supports the connector 4 and the hooks at the two lateral end portions of the buckle 5 to form a buckle coordination. The buckle coordination is relatively stable, and will not lead to loosening of the illumination assembly 3 during normal operation of the passenger conveyor. If the buckle coordination is to be disengaged, an appropriate force is only needed to pull the connector 4 outwards, and also due to coordination action of hooks, the supports of the connector 4 contract again to disengage the buckle coordination. As shown by combining FIG. 1, the buckle 5 is mounted in a channel in the base, such that the illumination assembly 3 can be quickly mounted in the channel of the base or quickly dismantled from the channel.

In addition, a cavity is formed between the connector 4 and the buckle 5, so as to conveniently dispose other parts. Take the illustration of FIG. 2 for example, a cable 6 for the illumination assembly 3 is disposed in this cavity. The illumination assembly 3 further comprises a luminophor 8, a waterproof material 7 for avoiding water and other foreign objects, and a luminophor carrier 7 that is usually made of metal and is for quick dissipation of heat; these arrangements belong to common arrangements of the illumination assembly, and thus are not further described in details.

The above novel constitution provides several advantages over the prior art. Firstly, the buckle coordination between the connector 4 and the buckle 4 enables the illumination assembly 3 to realize the fast detachment and combination with the base 1. Take the illumination assembly 3 as shown in FIG. 2 for example, when the illumination assembly 3 needs to be replaced due to failure or aging, it is not necessary to dismantle the base 1 from the lateral structure of the passenger conveyor, only an appropriate pull force is applied to the connector 4 that carries the illumination assembly 3 to disengage the connector 4 and the buckle 5, thereby dismantling the connector 4 and the illumination assembly 3 attached thereon from the passenger conveyor. The replaced illumination assembly 3 can also be fixed on the base by simply pressing the connector 4 carrying the illumination assembly 3 against the channel of the base 1. This replacement manner is simple and rapid, and is suitable for being implemented at maintenance site of the passenger conveyor. In addition, forming a cavity between the connector 4 and the buckle 5, can more conveniently dispose some accessories, such as a cable 6. The cavity not only provides a necessary space for disposing the cable, but also provides appropriate protection for the cable, which is especially favorable for the passenger conveyor operating outdoors.

It should be understood that, the so-called “rapid fixation means” is not limited to specific configuration as shown in FIG. 2, and shall be construed as various variants that can be conceived by persons skilled in the art to realize the fast detachment and combination effect as stated by the present utility model. For example, certain changes occur in the shapes and coordination manners of hooks, e.g., a deformable tenon head and a corresponding tenon channel are formed at the supports of the connector 4 and two lateral end portions of the buckle 5 respectively. Moreover, the relative arrangements of the fixation means can also be changed, e.g., the buckle 5 can be used for supporting parts to be fixed, such as the illumination assembly 3, while the connector 4 having the supports is fixed in the channel in the base 1. As long as the same technical effects that are realized by the hooks capable of detaching and coordinating as stated in the above text can be realized, it shall be construed as falling within the scope for which the present utility model intends to seek protection.

FIG. 3 shows another example of the present utility model, wherein the illumination assembly 3 and the brush 2 both are fixed into the channels of the base 1 by adopting the rapid fixation means as stated above. The brush 2 is located in the channel at the top and while the illumination assembly 3 is located in the channel at the bottom. As such, the rapid mounting and dismantling of both the brush and the assembly on the base can be realized.

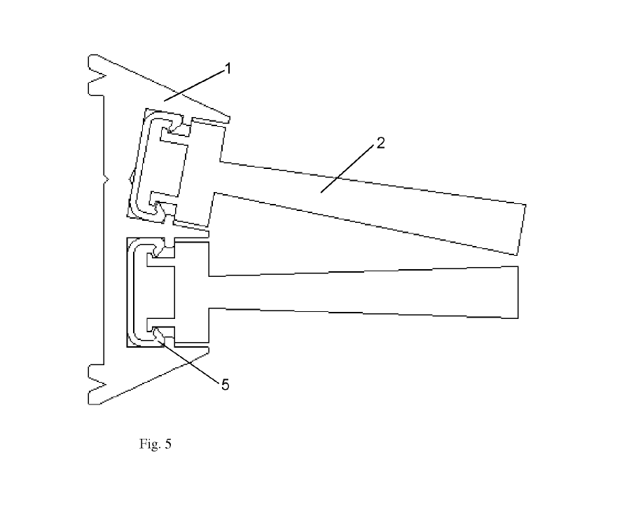

FIG. 4 shows another example of the present utility model, wherein the channels of the illumination assembly 3 and the brush 2 are interchanged, as compared with the example as shown in FIG. 3.

FIG. 5 shows a further example of the present utility model, wherein both channels of the base 1 are used to fix the brush by adopting the rapid fixation means of the present utility model, without fixing the illumination assembly 3.

Evidently, although the figures show a double-row base, persons skilled in the art can also conceive of applying the rapid fixation means of the present utility model in a common single-row base, which can also achieve the effect of simplifying the on-site changing and maintaining tasks of the brush.

The rapid fixation means of the present utility model does not need to make substantive transformations to the existing passenger conveyors, but can realize the on-site rapid changing and maintaining of the brush and illumination assembly and other possible similar devices, and thus has a great meaning in actual applications.

The present text uses illustrative examples to disclose the present utility model, comprising best modes, and also enables persons skilled in the art to carry out the present utility model. The patentable scope that can be obtained by the present utility model is defined by the claims, and can comprise other illustrative examples that are conceived by persons skilled in the art. If these other illustrative examples comprise structural elements that are not different from the literal language of the claims, or comprise equivalent structural elements that have no substantive differences from the literal language of the claims, these other illustrative examples all belong to the scope of the claims.

1. A rapid fixation means, for mounting onto a base of a lateral structure of a passenger conveyor, the rapid fixation means comprising a connector and a buckle in coordination with one another, the connector having supports capable of elastic deformation, the buckle having a feature of forming a coordination with the supports of the connector, the coordination enabling the connector and the buckle to be rapidly joined and detached;
wherein the base of the passenger conveyor has a single channel, and the parts of the passenger conveyor are fixed into the single channel using the rapid fixation means.

2. The rapid fixation means according to claim 1, characterized in that, a cavity is formed between the connector and the buckle.

3. The rapid fixation means according to claim 1, characterized in that, the supports of the connector form at tail ends hooks that protrude outwards, the buckle forms at lateral end portions hooks that protrude inwards and coordinate with the hooks of the supports at the tail ends, and the hooks protruding outwards at the tail ends of the supports and the hooks protruding inwards at the lateral end portions of the buckle overlap in width.

4. The rapid fixation means according to claim 1, characterized in that, the connector is capable of being rapidly mounted and dismantled, while the bucket is fixed into a channel of the base on the lateral structure of the passenger conveyor.

5. The rapid fixation means according to claim 1, characterized in that, the buckle is capable of being rapidly dismantled and mounted, while the connector is fixed into the channel of the base on the lateral structure of the passenger conveyor.

6. The rapid fixation means according to claim 1, characterized in that, a brush of the passenger conveyor is fixed into the channel of the base using the rapid fixation means.

7. The rapid fixation means according to claim 2, characterized in that, an illumination assembly is fixed into the channel of the base using the rapid fixation means, and a cable of the illumination assembly is disposed in the cavity between the connector and the buckle.

8. The rapid fixation means according to claim 1, characterized in that, the base of the passenger conveyor has two channels, and parts of the passenger conveyor are fixed into one of these two channels using the rapid fixation means.

9. (canceled)
